(19) United States
(12) Patent Application Publication
(10) Pub. No.: US 2010/0182376 A1
(43) Pub. Date: Jul. 22, 2010

(54) INK-JET HEAD

(75) Inventors: Boum-Seock KIM, Suwon-si (KR); Jae-Woo JOUNG, Suwon-si (KR); Ju-Hwan YANG, Suwon-si (KR); Young-Seuck YOO, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/503,451

(22) Filed: Jul. 15, 2009

(30) Foreign Application Priority Data
Jan. 21, 2009 (KR) 10-2009-0005130

(51) Int. Cl. B41J 2/14

(52) U.S. Cl. 347/47

(57) ABSTRACT

An ink-jet head is disclosed. The ink-jet head can include a chamber for holding ink, an actuator that can provide pressure to the chamber, and a nozzle that includes a multiple number of channels for ejecting the ink. Certain embodiments of the invention can reduce the surface tension of the ink droplets and thereby reduce the capacity requirement of the actuators.

### CROSS-REFERENCE TO RELATED APPLICATIONS

This application claims the benefit of Korean Patent Application No. 10-2009-0005130, filed with the Korean Intellectual Property Office on Jan. 21, 2009, the disclosure of which is incorporated herein by reference in its entirety.

### BACKGROUND

1. Technical Field

The present invention relates to an inkjet head.

2. Description of the Related Art

An ink-jet head is a device that ejects ink in the form of droplets, by converting electrical signals into physical force. In recent times, the application of the ink-jet head has expanded beyond the graphic printing industry to manufacturing printed circuit boards and electronic parts, such as LCD panels, etc.

In order to improve the printing quality, current ink-jet printers are being produced with a larger number of nozzles installed in greater densities.

FIG. 1 is a cross-sectional view of a nozzle in an ink-jet head according to the related art. As illustrated in FIG. 1, an increase in the number of nozzles 13 can decrease the cross-section of each nozzle 13, and hence decrease the size of the ink droplet 1 formed on the nozzle face.

As the size of the ink droplet 1 is reduced, so is the radius of curvature r1, resulting in an increase in surface tension of the ink droplet 1. In other words, an ink-jet head that includes nozzles 13 in higher densities may require more power to eject an ink droplet 1.

As such, current demands may require higher operating power in operating the ink-jet head and may make it difficult to improve the ejection speed, frequency characteristics, etc., of the ink-jet head.

### SUMMARY

An aspect of the invention provides an ink-jet head having both a high density of nozzles and improved ejection characteristics.

Another aspect of the invention provides an ink-jet head that includes a chamber for holding ink, an actuator that can provide pressure to the chamber, and a nozzle that includes a multiple number of channels for ejecting the ink.

Here, the channels can be formed in constant intervals. Also, the channels can be formed in a nozzle face that is applied with a hydrophilic treatment, and the nozzle face can have a circular shape.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a nozzle in an ink-jet head according to the related art.

FIG. 2 is a cross-sectional view of an ink-jet head according to an embodiment of the invention.

FIG. 3 is a plan view of a nozzle in an ink-jet head according to an embodiment of the invention.

FIG. 4 is a cross-sectional view of a nozzle in an ink-jet head according to an embodiment of the invention.

### DETAILED DESCRIPTION

The ink-jet head according to certain embodiments of the invention will be described below in more detail with reference to the accompanying drawings. Those components that are the same or are in correspondence are rendered the same reference numeral regardless of the figure number, and redundant descriptions are omitted.

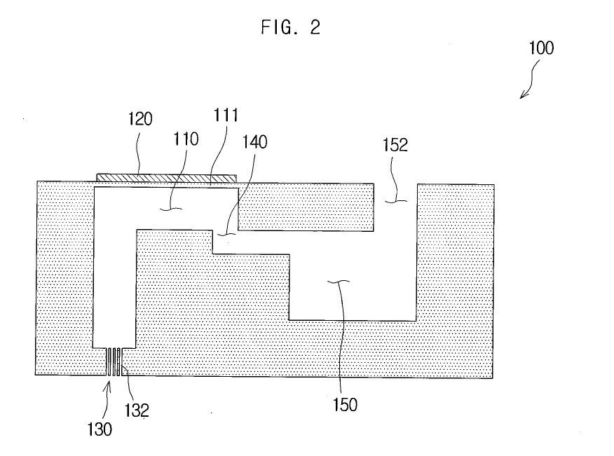

FIG. 2 is a cross-sectional view of an ink-jet head 100 according to an embodiment of the invention. As in the example shown in FIG. 2, an ink-jet head 100 based on an embodiment of the invention can include a reservoir 150, a restrictor 140, a chamber 110, a membrane 111, an actuator 120, and a nozzle 130.

The reservoir 150 can hold the ink and can supply the ink through the restrictor 140 to the chamber 110. The reservoir 150 can be supplied with the ink from outside the ink-jet head 100 through an inlet 152.

The restrictor 140 can connect the reservoir 150 with the chamber 110, and can serve as a channel through which ink may be supplied from the reservoir 150 to the chamber 110.

The restrictor 140 can be formed with a smaller cross-section than that of the reservoir 150. When an actuator 120 applies pressure to the chamber 110, the restrictor 140 can control the flow of ink from the reservoir 150 to the chamber 110.

One end of the chamber 110 can be connected with the restrictor 140, while the other end can be connected with the nozzle 130. The chamber 110 can be formed inside the ink-jet head 100 for holding the ink, and can have one side covered by the membrane 111.

The actuator 120 can be coupled onto the membrane 111. The actuator 120 can provide pressure to the chamber 110 and can include, for example, a piezoelectric element. When electric voltage is supplied, the piezoelectric element may be deformed in a vertical direction, thereby providing pressure to the chamber 110 by way of the membrane 111.

The nozzle 130 can be formed opposite the actuator 120 with the chamber 110 in-between. When pressure is applied, the ink stored in the chamber 110 may be ejected through the nozzle 130 to the exterior of the ink-jet head 100.

Here, the nozzle 130 can include a multiple number of channels 132, so as to reduce the surface tension of the ink droplet and thus reduce the amount of pressure that the actuator 120 has to apply to the chamber 110.

Since the same ejection characteristics can be implemented using a piezoelectric element having a lower piezoelectricity, the density of nozzles 130 and the ejection performance of the ink-jet head 100 can be improved without additional measures for improving the piezoelectricity of the piezoelectric element.

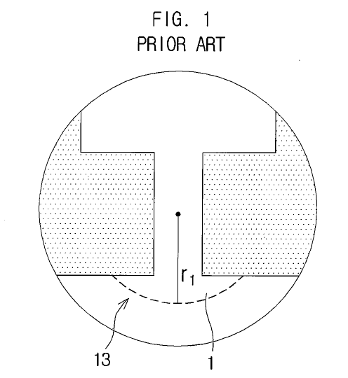

The channels 132 can be formed extending along a longitudinal direction, connecting the chamber 110 with the exterior of the ink-jet head 100. The multiple number of channels 132 can be grouped together. The cross-section of a channel 132 can be smaller than that of a nozzle in a typical ink-jet head. Also, the sum of the cross-sections of the multiple channels 132 forming the nozzle 130 in the ink-jet head 100 according to an embodiment of the invention can be smaller than the cross-section of the nozzle 13 in the ink-jet head illustrated in FIG. 1.

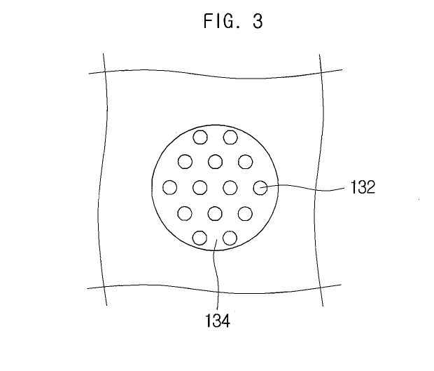

FIG. 3 is a plan view of a nozzle 130 of an ink-jet head 100 according to an embodiment of the invention. As in the example shown in FIG. 3, the channels 132 can be formed within a circular nozzle face 134. Each channel 132 may form a vertex of a regular triangle, with a constant distance between adjacent channels 132. In other words, the channels 132 can be evenly distributed within the nozzle face 134.

The nozzle face 134 can be a separate area on the side of the ink-jet head 100 in which the nozzle 130 is formed. The several channels 132 formed in one nozzle face 134 can function as a single nozzle 130.

The ink-jet head 100 described above can have one side applied with a hydrophobic treatment, but with the area of the nozzle face 134 applied with a hydrophilic treatment. In this way, the area of the nozzle face 134 where an ink droplet is formed can be delimited. The nozzle face 134 can be formed in a circular shape, so that the ink droplet may readily be formed on the nozzle face 134 with a circular cross-section.

While this particular embodiment has been described using an example in which the nozzle face 134 is formed in a circular shape, it is obvious that the nozzle face 134 can be formed in other shapes, such as squares or rectangles.

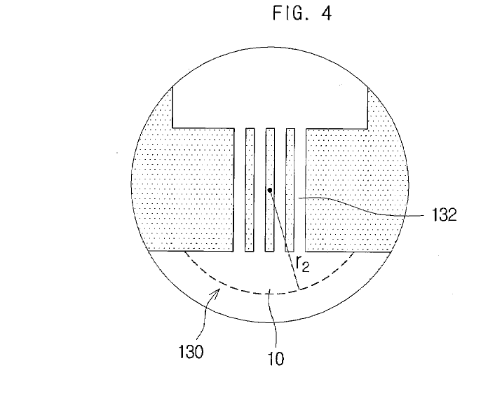

FIG. 4 is a cross-sectional view of a nozzle 130 of an ink-jet head 100 according to an embodiment of the invention. As in the example shown in FIG. 4, the ink issued from one channel 132 can combine with the ink issued from adjacent channels 132 to form a single ink droplet 10.

As described above, the channels 132 can be evenly distributed within the nozzle face 134 in constant intervals. This can prevent a decrease in radius of curvature of the ink droplet and a resultant increase in surface tension, which may occur when the ink droplet is formed only at the center of the nozzle face 134.

As the ink droplet 10 forms evenly over the entire nozzle face 134, in which the multiple channels 132 are formed, the radius of curvature r2 can be increased, and thus the surface tension of the ink droplet 10 can be reduced. As a result, the pressure that has to be applied by the actuator 120 to the chamber 110 for ejecting the ink droplet 10 can be reduced.

This makes it possible to reduce the capacity requirement for the actuator 120, as well as the operating power of the actuator 120. In this way, an ink-jet head 100 according to an embodiment of the invention can resolve the problem of lowered ejection performance caused by the increased nozzle density and decreased nozzle cross-section of the nozzles, by reducing the surface tension of the ink droplet 10 using a nozzle 130 composed of multiple channels 132.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An ink-jet head comprising:
a chamber for holding ink;
an actuator configured to provide pressure to the chamber; and
a nozzle including a plurality of channels for ejecting the ink.

2. The ink-jet head of claim 1, wherein the channels are formed in constant intervals.

3. The ink-jet head of claim 1, wherein the plurality of channels are formed in a nozzle face applied with a hydrophilic treatment.

4. The ink-jet head of claim 3, wherein the nozzle face has a circular shape.
